(19) United States
(12) Patent Application Publication
(10) Pub. No.: US 2008/0127271 A1
(43) Pub. Date: May 29, 2008

(54) Intelligent internet protocol television switching

(75) Inventors: Donald P. Zriny, Lucas, TX (US); Frederick H. Skoog, Colleyville, TX (US); Dhawal Moghe, Plano, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL, PARIS (FR)

(21) Appl. No.: 11/532,679

(22) Filed: Sep. 18, 2006

(51) Int. Cl. G06F 3/00

(52) U.S. Cl. 725/46

(57) ABSTRACT

A system, method, and computer readable medium for intelligent Internet Protocol Television switching, comprises profiling a set of user preferences, receiving an electronic program guide, and sending a data stream control message based upon the profiled set of user preferences and the received electronic program guide.

### BACKGROUND OF THE INVENTION

The present invention is generally related to Internet Protocol Television (IPTV) switching and, more specifically to intelligent IPTV switching utilizing an IPTV Electronic Program Guide (EPG) and user preference information.

Currently, an access node relies on the IPTV human user and a Set-Top Box (STB) to determine which media information streams to send within the subscriber's broadband data stream. For example, the user views an EPG that is stored in the STB, and selects a channel for viewing. The STB sends Internet Group Multicast Protocol (IGMP) messages to stop some streams such as video, audio and start others to begin the desired new channel associated media streams. This requires the STB to send multiple IGMP commands that are each acted upon independently within the access node. The user may also need to specify multiple choices to get the desired video and audio streams.

In current IPTV systems, the EPG is downloaded to each STB and viewed by the user. Upon selection of a new channel, the STB coordinates the removal of the previous channel components and establishes the new channel components.

In advanced IPTV networks using direct encapsulation of media streams many service options are available to the end user. There are multiple formats of video, such as High Definition and widescreen, multiple languages available, different audio formats, such as stereo and Dolby 5.1, and multiple ratings, such as, G, PG and R are available for the user to choose from. This information may need to be chosen every time the user changes to a new channel or a different TV within the home. An excessive number of transaction commands can burden the system if multiple devices under control of a access node change channels in the same time period.

Currently, there is no association of the EPG to user preferences within network access equipment. If the access node was able to coordinate information on the association of media stream multicast groups, such as access to the EPG, the channel selection switching process would be much more efficient.

Therefore, what is needed is intelligent IPTV program switching. More specifically, what is needed is an intelligent IPTV switching utilizing the IPTV EPG and user preference information.

### SUMMARY OF THE INVENTION

Network access equipment uses the information available in the IPTV EPG and the user preferences to improve the user's interaction with the IPTV system and the interaction of the STB with the network access equipment. The access node equipment receives from the user's equipment a request for a new channel within a single control message and determines the appropriate multicast groups to leave and join in order to deliver a complete IPTV program to the user. As such, fewer buttons need to be pushed on the user's remote control device for the desired video and audio selections, and fewer control commands need to be sent from the STB to the access equipment to accomplish the channel selection process. The network access equipment can be provisioned or pre-programmed by the user with user preferences and profile information. For each channel change selection, the preferences are used in association with the EPG to simplify channel selection and viewing.

During network access node startup, the IPTV EPG is requested by the access node control logic and downloaded by the IPTV middleware. The access node stores the EPG locally for use by the node application control logic when a service request is received from a user device such as a set top box. The application control logic responds to the service request to establish the media channel connections for the requested multimedia service sessions. The access node is programmed to receive updates to the EPG as they become available. The user profile information is programmed into the access equipment either by the network and/or the user via the user's device such as the set top box. Many user preferences can be stored at, and used by, the access equipment, along with the EPG. Added information within the IPTV EPG can be made available to assist in the determination of associations of program streams. As an example, groups of media streams can be associated with a single number group identification code used to select a set of multicast data flows that compose a complete IPTV program.

In the present invention, certain channels may be less desired as a user preference; therefore the access equipment will not display them when a channel up or a channel down is selected. Certain channels may be more desired as a user preference; therefore the access equipment will group those channels closer together while using the channel up/down commands. If children have access to a TV, restrictions on content, audio, times of use, etc. may be enforced by the access equipment as a user preference. Also, access equipment may be provisioned with the type of audio and video equipment in use by a particular STB, and selection of the optimum format can be set as a user preference. Additionally, a default language preference can be stored at the access equipment to request the appropriate language stream associated with the video channel.

The present invention enables less repetitive input by the user and fewer commands to the access equipment, which expedites channel changing and reduces DSL line load. With the present invention, a user will get the correct IPTV channel more rapidly (and not be burdened by unnecessary channel up or channel down selections), and the access equipment will not be burdened by multiple, unnecessary channel change requests.

In one embodiment of the present invention, a method for intelligent internet protocol television switching, comprises profiling a set of user preferences, receiving an electronic program guide, and sending a data stream control message based upon the profiled set of user preferences and the received electronic program guide. The method may also comprise associating the profiled set of user preferences to the received electronic program guide and grouping a channel selection display based upon a channel selection preference, wherein the data stream control message may be an Internet group multicast protocol message, the profiled set of user preferences may include a channel selection preference and the profiled set of user preferences may include a channel de-selection preference, and wherein the profiled set of user preferences may include a set of restriction criteria, the profiled set of user preferences may include a video format criteria and the profiled set of user preferences may include an audio format criteria and the profiled set of user preferences includes a language format criteria.

In a further embodiment of the present invention, a computer readable medium comprises instructions for profiling a set of user preferences, receiving an electronic program guide, associating the profiled set of user preferences to the received electronic program guide, filtering a data stream control message based upon the associated profiled set of user preferences and the received electronic program guide, and sending the filtered data stream control message. The computer readable medium may comprise grouping a channel selection display based upon a channel selection preference and updating the electronic program guide at a predetermined time interval, wherein the profiling of the set of user preferences may be performed by a network, the profiling of the set of user preferences may be performed by a user device and the data stream control message may be an internet group multicast protocol message.

In yet a further embodiment, a system of intelligent internet protocol television switching comprises a memory that receives a set of user preferences and an electronic program guide, and a processor communicably coupled to the memory, wherein the processor profiles the set of user preferences, receives the electronic program guide, and sends a data stream control message based upon the profiled set of user preferences and the received electronic program guide. The processor may also associate the profiled set of user preferences to the received electronic program guide and filter the data stream control message based upon the associated profiled set of user preferences and the received electronic program guide, wherein the data stream control message may be an internet group multicast protocol message.

### BRIEF DESCRIPTION OF THE DRAWINGS

FIG. 1 illustrates a first system of intelligent IPTV switching that includes an embodiment of the present invention as a portion thereof;

FIG. 2 illustrates a first method flow diagram in accordance with an embodiment of the present invention;

FIG. 3 illustrates a second method flow diagram in accordance with an embodiment of the present invention;

FIG. 4 illustrates a first software flow diagram of intelligent IPTV switching in accordance with an embodiment of the present invention;

FIG. 5 illustrates a second software flow diagram of intelligent IPTV switching in accordance with an embodiment of the present invention;

FIG. 6 illustrates a second system of intelligent IPTV switching in accordance with an embodiment of the present invention; and

FIG. 7 illustrates a third system of intelligent IPTV switching in accordance with an embodiment of the present invention.

### DETAILED DESCRIPTION OF THE INVENTION

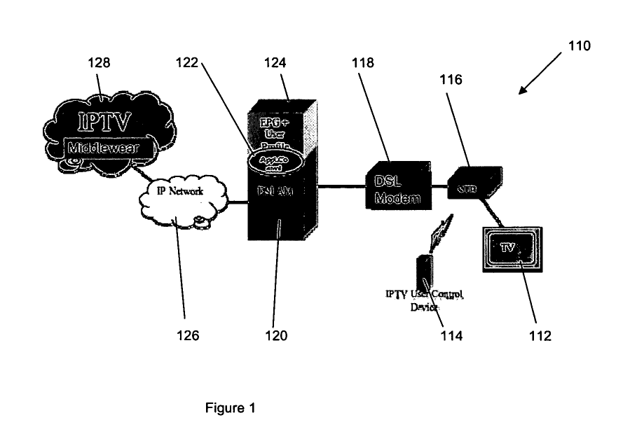

Referring now to FIG. 1, a first system of intelligent Internet Protocol Television (IPTV) switching 110 is depicted and comprises a number of blocks or modules that are software, hardware, or firmware, and/or a combination of software, hardware, and/or firmware. This figure illustrates just one example of a carrier based IPTV access system that performs the channel (multimedia session) switching function. The functionality stated in this patent would also apply to other network access systems (e.g. GPON etc.) An IPTV 112 is controlled by a user control device 114. The IPTV is connected to a set top box (STB) 116, which is in turn connected to a DSL modem 118. The modem is connected to a Digital Subscriber Line Access Multiplexer (DSLAM) 120 that is in communication with a software application 122 that accesses an Electronic Program Guide (EPG) and user profile 124. The DLSAM is in communication with an Internet Protocol (IP) network 126 that is in communication with IPTV middleware 128. The software application 122 forms the basis of the present invention. In other embodiments of the present invention, the software application 122, or the functionality performed by the software application, can be positioned in or distributed across one or more of the depicted blocks or modules or other, non-depicted, blocks or modules.

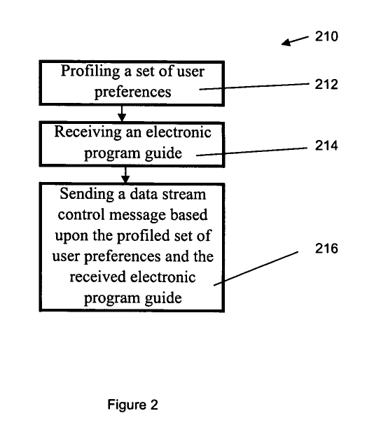

Referring now to FIG. 2, a first method of intelligent IPTV switching 210 is depicted and comprises a number of blocks or modules that are software, hardware, or firmware, and/or the combination of software, hardware, and/or firmware. The method comprises profiling 212 a set of user preferences, receiving 214 an electronic program guide and sending 216 a data stream control message based upon the profiled set of user preferences and the received electronic program guide. The transfer of information between the modules occurs via at least one of: a wireless protocol, a wired protocol and a combination of the wireless protocol and the wired protocol.

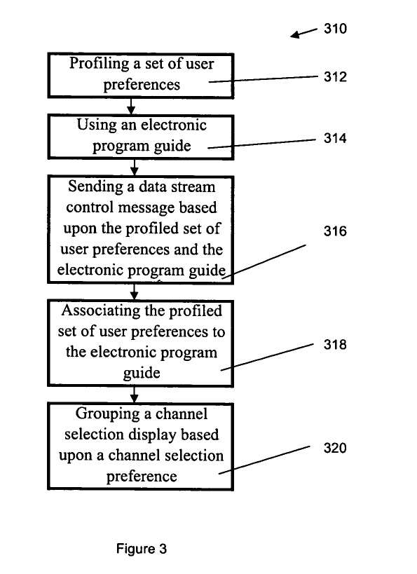

Referring now to FIG. 3, a second method of intelligent IPTV switching 310 is depicted and comprises a number of blocks or modules that are software, hardware, or firmware, and/or the combination of software, hardware, and/or firmware. The method comprises profiling 312 a set of user preferences, using 314 an electronic program guide, and sending 316 a data stream control message based upon the profiled set of user preferences and the electronic program guide. The method may also comprise associating 318 the profiled set of user preferences to the electronic program guide and grouping 320 a channel selection display based upon a channel selection preference, wherein the data stream control message may be an internet group multicast protocol message, the profiled set of user preferences may include a channel selection preference and the profiled set of user preferences may include a channel de-selection preference, wherein the profiled set of user preferences may include a set of restriction criteria, the profiled set of user preferences may include a video format criteria and the profiled set of user preferences may include an audio format criteria and the profiled set of user preferences includes a language format criteria. The transfer of information between the modules occurs via at least one of: a wireless protocol, a wired protocol and a combination of the wireless protocol and the wired protocol.

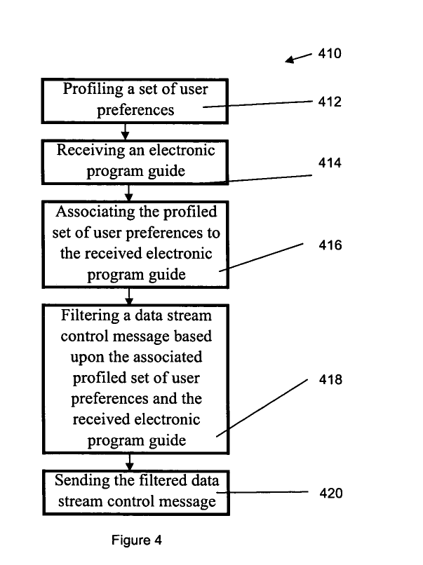

Referring now to FIG. 4, a first software flow diagram 410 of intelligent IPTV switching is depicted. The software, or a computer readable medium comprises instructions for, profiling 412 a set of user preferences, receiving 414 an electronic program guide and associating 416 the profiled set of user preferences to the received electronic program guide. The computer readable medium comprises instructions for filtering 418 a data stream control message based upon the associated profiled set of user preferences and the received electronic program guide, and sending 420 the filtered data stream control message. These steps may also be embodied in firmware and/or hardware. The transfer of information occurs via at least one of a wireless protocol, a wired protocol and the combination of the wireless protocol and the wired protocol.

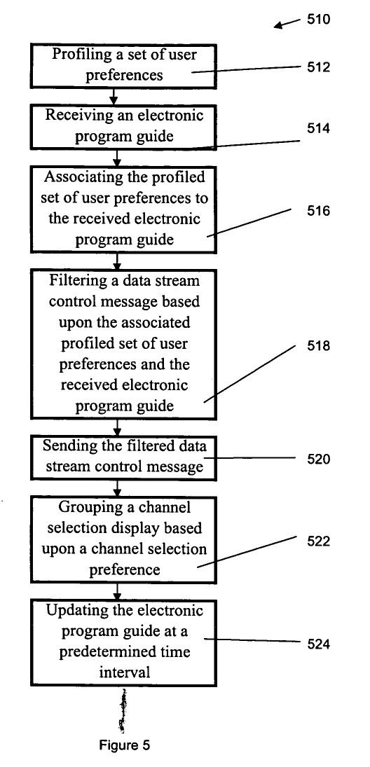

Referring now to FIG. 5, a second software flow diagram 510 of intelligent IPTV switching is depicted. The software, or a computer readable medium comprises instructions for, profiling 512 a set of user preferences, receiving 514 an electronic program guide and associating 516 the profiled set of user preferences to the received electronic program guide. The computer readable medium also comprises filtering 518 a data stream control message based upon the associated profiled set of user preferences and the received electronic program guide, and sending 520 the filtered data stream control message. The computer readable medium comprises instructions for grouping 522 a channel selection display based upon a channel selection preference and updating 524 the electronic program guide at a predetermined time interval, wherein the profiling of the set of user preferences may be performed by a network, the profiling of the set of user preferences may be performed by a user device and the data stream control message may be an internet group multicast protocol message. These steps may also be embodied in firmware and/or hardware. The transfer of information occurs via at least one of a wireless protocol, a wired protocol and the combination of the wireless protocol and the wired protocol.

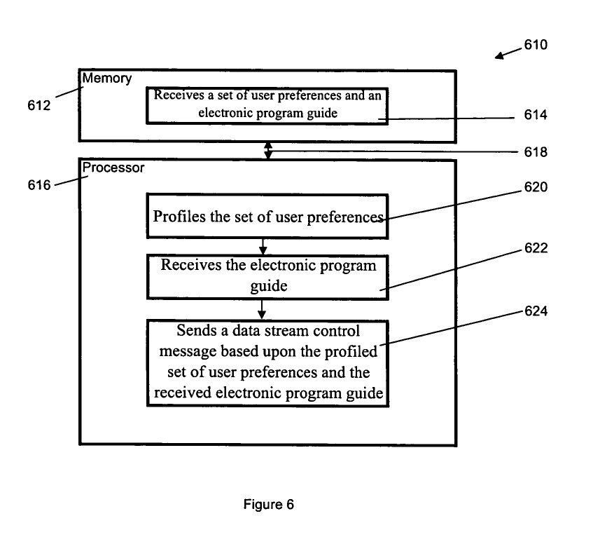

Referring now to FIG. 6, a first system 610 of intelligent IPTV switching is depicted. The system comprises a memory 612 that receives 614 a set of user preferences and an electronic program guide, and a processor 616 communicably coupled 618 to the memory. The processor profiles 620 the set of user preferences, receives 622 the electronic program guide and sends 624 a data stream control message based upon the profiled set of user preferences and the received electronic program guide. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

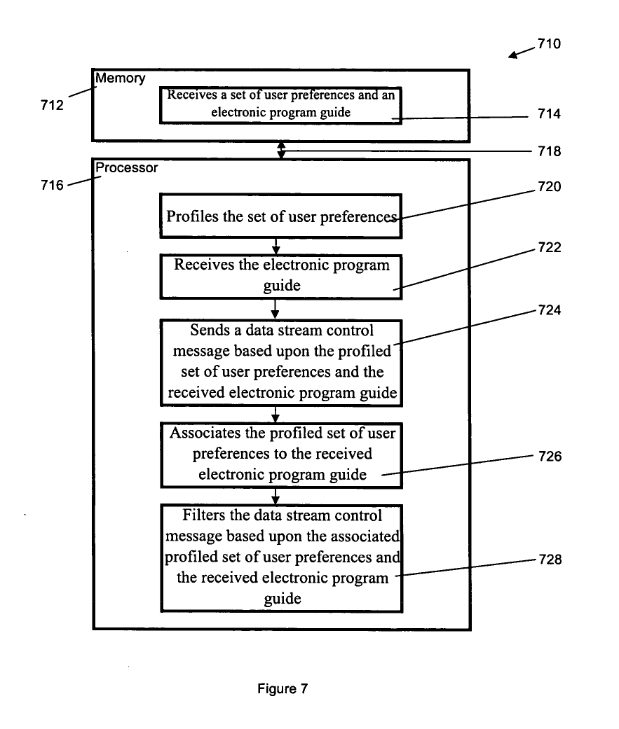

Referring now to FIG. 7, a second system 710 of intelligent IPTV switching is depicted. The system comprises a memory 712 that receives 714 a set of user preferences and an electronic program guide, and a processor 716 communicably coupled 718 to the memory. The processor profiles 720 the set of user preferences, receives 722 the electronic program guide and sends 724 a data stream control message based upon the profiled set of user preferences and the received electronic program guide. The processor may also associate 726 the profiled set of user preferences to the received electronic program guide and filter 728 the data stream control message based upon the associated profiled set of user preferences and the received electronic program guide, wherein the data stream control message may be an Internet group multicast protocol message. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for intelligent Internet Protocol Television switching, comprising:
profiling a set of user preferences;
receiving an electronic program guide; and
sending a data stream control message based upon the profiled set of user preferences and the received electronic program guide.

2. The method of claim 1 comprising:
associating the profiled set of user preferences to the received electronic program guide.

3. The method of claim 1 wherein the data stream control message is an Internet Group Multicast Protocol message.

4. The method of claim 1 wherein the profiled set of user preferences includes a channel selection preference.

5. The method of claim 4 wherein the profiled set of user preferences includes a channel de-selection preference.

6. The method of claim 1 comprising:
grouping a channel selection display based upon a channel selection preference.

7. The method of claim 1 wherein the profiled set of user preferences includes a set of restriction criteria.

8. The method of claim 1 wherein the profiled set of user preferences includes a video format criteria.

9. The method of claim 1 wherein the profiled set of user preferences includes an audio format criteria.

10. The method of claim 1 wherein the profiled set of user preferences includes a language format criteria.

11. A computer readable medium comprising instructions for:
profiling a set of user preferences;
receiving an electronic program guide;
associating the profiled set of user preferences to the received electronic program guide;
filtering a data stream control message based upon the associated profiled set of user preferences and the received electronic program guide; and
sending the filtered data stream control message.

12. The computer readable medium of claim 11 wherein the profiling of the set of user preferences is performed by a network.

13. The computer readable medium of claim 11 wherein the profiling of the set of user preferences is performed by a user device.

14. The computer readable medium of claim 11 wherein the data stream control message is an Internet Group Multicast Protocol message.

15. The computer readable medium of claim 11 comprising:
grouping a channel selection display based upon a channel selection preference.

16. The computer readable medium of claim 11 comprising:
updating the electronic program guide at a predetermined time interval.

17. A system of intelligent Internet Protocol Television switching, comprising:
a memory that receives a set of user preferences and an electronic program guide; and
a processor communicably coupled to the memory, wherein the processor:
profiles the set of user preferences;
receives the electronic program guide; and
sends a data stream control message based upon the profiled set of user preferences and the received electronic program guide.

18. The system of claim 17 wherein the processor associates the profiled set of user preferences to the received electronic program guide.

19. The system of claim 18 wherein the processor filters the data stream control message based upon the associated profiled set of user preferences and the received electronic program guide.

20. The system of claim 17 wherein the data stream control message is an Internet Group Multicast Protocol message.
